(19) United States
(12) Patent Application Publication
(10) Pub. No.: US 2026/0311534 A1
(43) Pub. Date: Oct. 8, 2026

(54) ACCESS CONTROL APPARATUS AND METHOD USING FACIAL RECOGNITION

(71) Applicants: HYUNDAI MOTOR COMPANY, Seoul (KR); Kia Corporation, Seoul (KR)

(72) Inventors: Kyunghwan CHO, Hwaseong-si (KR); Jung Eun KWON, Hwaseong-si (KR); Moonsub JIN, Hwaseong-si (KR); Jongwook KIM, Hwaseong-si (KR)

(21) Appl. No.: 19/292,165

(22) Filed: Aug. 6, 2025

(30) Foreign Application Priority Data
Apr. 7, 2025 (KR) 10-2025-0044587

(51) Int. Cl. G07C 9/37; G06V 40/16

(52) U.S. Cl. CPC G07C 9/37; G06V 40/165; G06V 40/172

(57) ABSTRACT

A method and apparatus for controlling entrance of an entrant are provided. The method includes receiving an image captured of an entrance area; calculating recognition scores representing a degree of recognition of a plurality of main landmarks at least one face area detected in the image, determining face attribute factors, occlusion weights of the face attribute factors indicating influences of the face attribute factors on face occlusion and face area information to which the face attribute factors correspond, in the at least one face area, and determining whether face recognition is possible for at least one face area based on the recognition scores, the occlusion weights of the face attribute factors, and the face area information.

### CROSS-REFERENCE TO RELATED APPLICATION

This application claims priority to and the benefit of Korean Patent Application No. 10-2025-0044587 filed with the Korean Intellectual Property Office on Apr. 7, 2025, the entire contents of which are incorporated herein by reference.

### TECHNICAL FIELD

The present disclosure relates to an access control apparatus and method using facial recognition.

### BACKGROUND

Most conventional facial recognition-based access systems rely on dedicated facial recognition terminals. When a user approaches such a terminal, the system performs facial authentication and then grants access.

These systems typically require the user to be within a specific proximity to the terminal for accurate facial recognition. As a result, when a plurality of users attempt to enter simultaneously, user entry may be delayed due to the need for sequential recognition.

### SUMMARY

The present disclosure is directed to an access control apparatus and method using facial recognition capable of reducing access delays when a plurality of users attempt to enter.

According to an aspect of the present disclosure, an access control method performed by executing one or more instructions stored in memory by a processor, can include receiving an image of an entrance area, detecting at least one face area in the image, calculating a plurality of recognition scores, each indicating a recognition degree for a corresponding one of a plurality of main landmarks within the at least one face area, determining a plurality of face attribute factors in the at least one face area, extracting, by searching a face attribute lookup table, (i) a plurality of occlusion weights of the plurality of face attribute factors, each occlusion weight indicating a degree to which a corresponding face attribute factor contributes to face occlusion and (ii) face area information corresponding to each face attribute factor, calculating a face occlusion score of the at least one face area based on the plurality of recognition scores of the plurality of main landmarks, the plurality of occlusion weights of the plurality of face attribute factors, and the face area information, determining, based on the face occlusion score of the at least one face area, whether face recognition can be performed for the at least one face area, identifying, from among the at least one face area deemed suitable for the face recognition, a user corresponding to a first face area, and notifying, based on the identification of the user being failed, an image of the first face area and a user identification failure.

In some implementations, calculating the face occlusion score can include setting, for each of the plurality of main landmarks, a weight based on the face area information, such that main landmarks corresponding to the face area information are assigned occlusion weights associated with the face attribute factors, and remaining main landmarks are assigned a default weight of 1, and calculating a face occlusion score by (i) multiplying a first value of each of the plurality of main landmarks, which is derived from the recognition score of each of the plurality of main landmarks, by the assigned weight of the main landmark and (ii) averaging a sum of the resulting weighted values. In some examples, the face attribute lookup table can include the plurality of occlusion weights of the plurality of face attribute factors based on a type of each of the plurality of face attribute factors, and the face area information to which a corresponding face attribute factor belongs, and occlusion weights associated with face attribute factors that contribute to face occlusion can be set to values greater than 1, and occlusion weights associated with face attribute factors unrelated to face occlusion can be set to values less than 1.

In some examples, the first value can be a value obtained by subtracting the recognition score of the corresponding main landmark from 1. In some implementations, determining whether face recognition can be performed can include determining, based on the face occlusion score of any one face being greater than or equal to a set first threshold, that a face recognition of the any one face area cannot be performed, and determining, based on face occlusion score of the any one face being less than the first threshold, that a face recognition of the any one face area can be performed.

In some implementations, identifying a user can include generating a first feature vector of the first face area, and verifying the user of the first face area by using a similarity measurement between the first feature vector and each of feature vectors of a plurality of face images of each of registered users with access authentication stored in a database. In some examples, the database can include a second feature vector of a front face image, a third feature vector of a left face image, and a fourth feature vector of a right face image, stored in correspondence with a user key of each of the registered users, and verifying the user can include calculating a first similarity between the first feature vector and the second feature vector of each registered user, a second similarity between the first feature vector and the third feature vector of each registered user, and a third similarity between the first feature vector and the fourth feature vector of each registered user, calculating a sum of the first similarity, the second similarity, and the third similarity calculated with each registered user, and determining, based on the calculated sum being less than a face identification threshold, that an identification of the user of the first face area has failed.

In some implementations, the access control method can further include extracting a yaw angle of the first face area, where verifying the user can further include extracting a front weight, a left weight, and a right weight corresponding to the yaw angle of the first face area by referring to an angle weight lookup table in which front weights, left weights, and right weights are set for a plurality of face yaw angles, and calculating the sum can include multiplying the first similarity by the front weight, multiplying the second similarity by the left weight, and multiplying the third similarity by the right weight, and then summing them.

In some implementations, the access control method can further include extracting a feature vector of a front face image of each registered user, a feature vector of a left face image of each registered user, and a feature vector of a right face image of each registered user, and registering, in the database, the feature vector of a front face image of each registered user, the feature vector of a left face image of each registered user, and the feature vector of a right face image of each registered user in correspondence with a user key of each registered user. In some examples, extracting a feature vector can include detecting a second face area from each of the front face image, the left face image, and the right face image, calculating a plurality of recognition scores of a plurality of main landmarks in the second face area of each of the front face image, the left face image, and the right face image, determining a plurality of face attribute factors in the second face area, extracting, by searching the face attribute lookup table, a plurality of attribute weights of the plurality of face attribute factors and face area information to which the plurality of face attribute factors correspond, calculating a face occlusion score of the second face area based on the plurality of recognition scores of the plurality of main landmarks, occlusion weights of the extracted plurality of face attribute factors, and the face area information, determining, based on the face occlusion score of the second face area, whether face recognition can be performed for the second face area, and generating, based on a determination that the face recognition can be performed, the feature vector of each of the front face image, the left face image, and the right face image.

In some examples, registering the feature vectors can include registering the face attribute factors corresponding to the user key, based on the face attribute factors determined in the second face area of each of the front face image, the left face image, and the right face image are a positive attribute factor that does not interfere with face recognition.

According to another aspect of the present disclosure, an access control apparatus can include a memory storing one or more instructions, and a processor configured to execute one or more instructions to perform operations. The operations can include detecting at least one face area in an image of an entrance area, calculating a plurality of recognition scores, each indicating a recognition degree for a corresponding one of a plurality of main landmarks within the at least one face area, determining a plurality of face attribute factors in the at least one face area, extracting, by searching a face attribute lookup table, (i) a plurality of occlusion weights of the plurality of face attribute factors, each occlusion weight indicating a degree to which a corresponding face attribute factor contributes to face occlusion and (ii) face area information corresponding to each face attribute factor, calculating a face occlusion score of the at least one face area based on the plurality of recognition scores of the plurality of main landmarks, the plurality of occlusion weights of the plurality of face attribute factors, and the face area information, determining, based on the face occlusion score of the at least one face area, whether face recognition can be performed for the at least one face area, identifying, from among the at least one face area deemed suitable for the face recognition, a user corresponding to a first face area, and notifying, based on the identification of the user being failed, an image of the first face area and a user identification failure.

In some implementations, calculating the face occlusion score can include setting, for each of the plurality of main landmarks, a weight based on the face area information, such that main landmarks corresponding to the face area information are assigned occlusion weights associated with the face attribute factors, and remaining main landmarks are assigned a default weight of 1, and calculating a face occlusion score by (i) multiplying a first value of each of the plurality of main landmarks, which is derived from the recognition score of each of the plurality of main landmarks, by the assigned weight of the main landmark and (ii) averaging a sum of the resulting weighted values.

In some examples, the face attribute lookup table can include the plurality of occlusion weights of the plurality of face attribute factors based on a type of each of the plurality of face attribute factors, and the face area information to which a corresponding face attribute factor belongs, occlusion weights associated with face attribute factors that contribute to face occlusion can be set to values greater than 1, and occlusion weights associated with face attribute factors unrelated to face occlusion can be set to values less than 1, and the operations can include searching the face attribute lookup table, and extracting attribute weights of the plurality of face attribute factors and the face area information.

In some examples, the first value can be a value obtained by subtracting the recognition score of the corresponding main landmark from 1. In some implementations, determining whether face recognition can be performed can include determining, based on the face occlusion score of any one face being greater than or equal to a set first threshold, that a face recognition of the any one face area cannot be performed, and determining, based on face occlusion score of the any one face being less than the first threshold, that a face recognition of the any one face area can be performed.

In some implementations, the access control apparatus can further include a database configured to store a plurality of feature vectors of a plurality of face images of each registered user, where identifying a user can include generating a first feature vector of the first face area, and verifying the user of the first face area by using a similarity measurement between the first feature vector and each of feature vectors of the plurality of face images of each registered user stored in the database. In some examples, the feature vectors of a plurality of face images can include a second feature vector of a front face image, a third feature vector of a left face image, and a fourth feature vector of a right face image, stored in correspondence with a user key of each of the registered users, and verifying the user can include calculating a first similarity between the first feature vector and the second feature vector of each registered user, a second similarity between the first feature vector and the third feature vector of each registered user, and a third similarity between the first feature vector and the fourth feature vector of each registered user, calculating a sum of the first similarity, the second similarity, and the third similarity calculated with each registered user, and determining, based on the calculated sum being less than a face identification threshold, that an identification of the user of the first face area has failed.

In some examples, the operations can further include extracting a yaw angle of the first face area, where verifying the user can further include extracting a front weight, a left weight, and a right weight corresponding to the yaw angle of the first face area by referring to an angle weight lookup table in which front weights, left weights, and right weights are set for a plurality of face yaw angles, calculating the sum can include multiplying the first similarity by the front weight, multiplying the second similarity by the left weight, and multiplying the third similarity by the right weight, and then summing them. In some implementations, extracting a feature vector can include detecting a second face area from each of a front face image, a left face image, and a right face image of each registered user, calculating a plurality of recognition scores of a plurality of main landmarks in the second face area of each of the front face image, the left face image, and the right face image, determining a plurality of face attribute factors in the second face area, extracting, by searching the face attribute lookup table, a plurality of attribute weights of the plurality of face attribute factors and face area information to which the plurality of face attribute factors correspond, calculating a face occlusion score of the second face area based on the plurality of recognition scores of the plurality of main landmarks, occlusion weights of the extracted face attribute factors, and the face area information, determining, based on the face occlusion score of the second face area, whether face recognition can be performed for the second face area, and generating, based on a determination that the face recognition can be performed, the feature vector of each of the front face image, the left face image, and the right face image.

### BRIEF DESCRIPTION OF THE DRAWINGS

FIG. 1 is a schematic diagram illustrating an example of a facial recognition access system.

FIG. 2 is a diagram illustrating an example of the access control apparatus illustrated in FIG. 1 in more detail.

FIG. 3 is a flowchart illustrating an example of a user registration method for access control of the access control apparatus illustrated in FIG. 1.

FIG. 4 is a diagram illustrating an example of a face attribute lookup table.

FIG. 5 is a diagram illustrating an example of information stored in the database illustrated in FIG. 2.

FIG. 6 is a flowchart illustrating an example of an access control method of the access control apparatus illustrated in FIG. 1.

FIG. 7 is a diagram illustrating an example of an angular weight lookup table.

FIG. 8 is a diagram illustrating an example of a method for calculating a face occlusion score for a single face area.

FIG. 9 is a diagram illustrating an example of a method for calculating a face occlusion score for another face area.

FIG. 10 is a diagram illustrating an example of a facial attribute-based search method when user identification of the face area illustrated in FIG. 6 fails.

### DETAILED DESCRIPTION

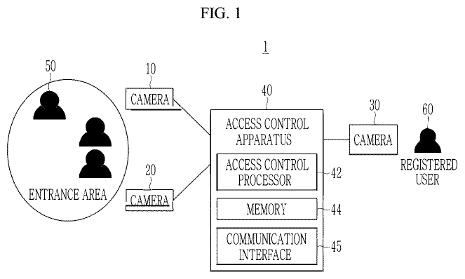

FIG. 1 is a schematic diagram illustrating an example of a facial recognition access system.

Referring to FIG. 1, the facial recognition access system 1 can include a plurality of cameras, for example, a first camera 10, a second camera 20, a third camera 30, and an access control apparatus 40.

The first camera 10 and the second camera 20 can be installed at each entrance location, and can capture images of enter access users 50 attempting to enter the entrance area and transmit the captured images to the access control apparatus 40.

In some implementations, the first camera 10 can be installed on an upper left side of an entrance door, and the second camera 20 can be installed on an upper right side of the entrance door.

In this way, if the first camera 10 and the second camera 20 are installed at different locations of the entrance door, the entrance area can be captured from different angles by the first camera 10 and the second camera 20, and accordingly, in a situation where a plurality of users enter and exit, even if the face of any enter access user is not detected in the image of the first camera 10, it can be detected in the image of the second camera 20 that is captured from a different angle than the first camera 10.

In some implementations, a plurality of cameras, including the first camera 10 and the second camera 20, can be installed at different distances from the location of the entrance door in the entrance area, and a moving robot camera can also be installed. In this way, even if the face image of a user is obscured by another user in the image captured by one camera, the possibility of detection in the image captured by another camera or the moving robot camera can be increased.

The third camera 30 can capture images of a registered user 60 who are authenticated for entry and transmit the captured images of registered user 60 to the access control apparatus 40. The images of the registered user 60 can include a frontal face image captured from the front of the registered user 60, a left face image captured from the left side of the registered user 60, and a right face image captured from the right side of the registered user 60.

The first camera 10, the second camera 20, and the third camera 30 can be connected to the access control apparatus 40 wired or wirelessly. The first camera 10, the second camera 20, and the third camera 30 can include a wireless communication module when wirelessly connected to the access control apparatus 40.

The access control apparatus 40 can include an access control processor 42, memory 44, and a communication interface 46.

The access control processor 42 can control the overall operation of each component of the access control apparatus 40. The access control processor 42 can be implemented with at least one of various processing units such as a central processing unit (CPU), a graphic processing unit (GPU), a microprocessor unit (MPU), a micro controller unit (MCU), etc., and can also be implemented with a parallel processing unit. In addition, the access control processor 42 can perform operations on a computer programs for executing the access control method.

The access control processor 42 can store the computer programs for executing the access control method in the memory 44.

The computer program can include instructions that cause the access control processor 42 to perform an access control method of the access control apparatus 40 when loaded into the memory 44. The access control processor 42 can perform operations for an access control method of the access control apparatus 40 by executing instructions.

The memory 44 can load the computer program from a storage device to execute the access control method of the access control apparatus 40. The storage device can store programs non-temporarily. The storage device can be implemented as non-volatile memory.

The communication interface 46 can support wired and wireless Internet communication of the access control apparatus 40. In addition, the communication interface 46 can support various communication methods other than Internet communication. The access control processor 42 can receive images captured by the cameras 10, 20, and 30 through the communication interface 46.

The access control processor 42 can register information of the registered user 60 by executing the computer program. The access control processor 42 determines whether the front face image, left face image, and right face image of the registered user 60 can be registered respectively, and if it is determined that registration is possible, it can generate a feature vector from each of the front face image, the left face image, and the right face image, and stores the front face image, the left face image, and the right face image and the feature vectors of the corresponding face images in a database, thereby enabling registration of the information of the registered user 60.

The access control processor 42 can identify enter access users 50 from images received from each of the first camera 10 and the second camera 20 by executing the computer program. The access control processor 42 can detect a face area of each of the enter access users 50 from images received from each of the first camera 10 and the second camera 20, and can identify the access users 50 using the detected face area of each of the enter access users 50. The access control processor 42 generates a feature vector from the face area of each of the enter access users 50, calculates the similarities between the feature vector of each of the enter access users 50 and the feature vectors of the front face image, left face image, and right face image of registered users stored in the database, thereby identifying each of the enter access users 50.

When an unidentified access user occurs, the access control processor 42 can output an alarm notifying the occurrence of an unidentified access user and an image of the unidentified access user.

In this way, the access control apparatus 40 can detect the face areas of a plurality of enter access users 50 from images received from the first camera 10 and the second camera 20 and identify each of the plurality of enter access users 50. Accordingly, even if the plurality of enter access users occur at the same time, since each enter access user does not need to have his or her face recognized by the facial recognition terminal, there can be no delay in enter access.

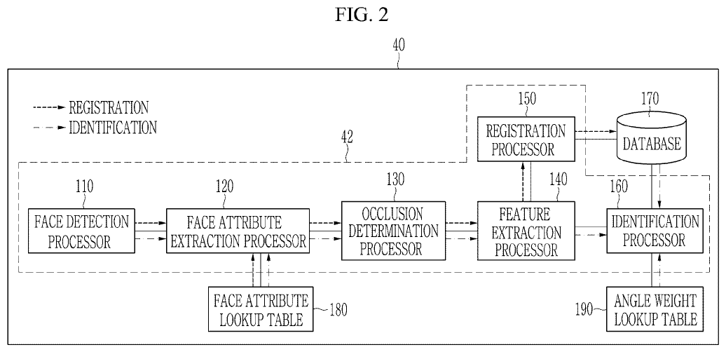

FIG. 2 is a drawing showing the access control apparatus illustrated in FIG. 1 in more detail. For convenience, the memory 44 and the communication interface 46 are omitted in FIG. 2.

Referring to FIG. 2, the access control processor 42 of the access control apparatus 40 can include a face detection processor 110, a face attribute extraction processor 120, an occlusion determination processor 130, a feature extraction processor 140, a registration processor 150, an identification processor 160, and a database 170.

In addition, the access control apparatus 40 can further include a face attribute lookup table 180 and an angle weight lookup table 190.

The database 170, face attribute lookup table 180, and angle weight lookup table 190 can be stored in memory (44 in FIG. 1) or a storage device.

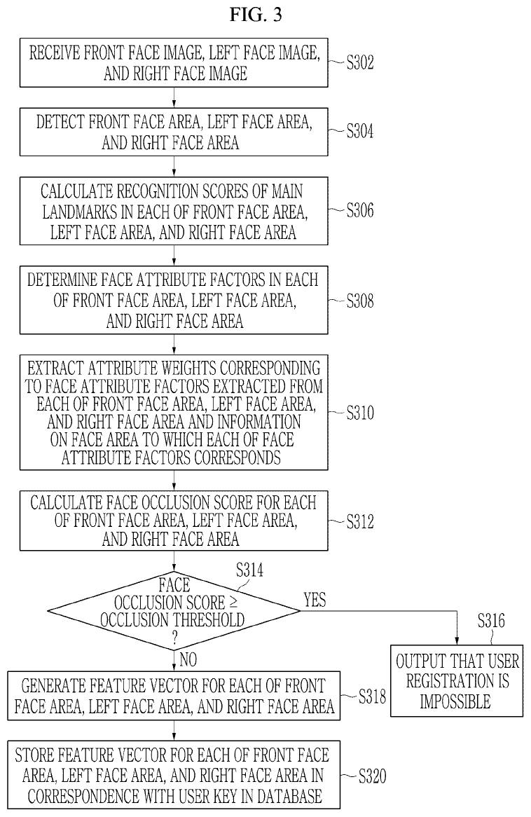

FIG. 3 is a flowchart illustrating a user registration method for access control of the access control apparatus illustrated in FIG. 1.

Referring to FIGS. 2 and 3 together, the face detection processor 110 receives a front face image, a left face image, and a right face image of a registered user 60 from the third camera 30 (S302).

The third camera 30 can capture a registered user 60 at three angles of a frontal angle, a left angle, and a right angle, and transmit a front face image of the registered user 60 captured at the front angle, a left face image of the registered user 60 captured at the left angle, and a right face image of the registered user 60 captured at the right angle to the face detection processor 110.

The face detection processor 110 can detect face areas, i.e., front face area, left face area, and right face area, from each of the front face image, left face image, and right face image of the registered user 60 (S304).

In some implementations, the face detection processor 110 can detect a face area in an input image using a learned face detection model.

The face attribute extraction processor 120 can extract a plurality of landmark points from each of the front face area, the left face area, and the right face area, and calculate recognition scores of the plurality of landmark points. The recognition score of a landmark point is a value that represents the degree of recognition of the landmark point. If the landmark point is recognized well without being obscured, the recognition score of the landmark point can have a value close to 1, and if the landmark point is largely obscured by facial attributes, the recognition score of the landmark point can have a value close to 0.

In addition, the face attribute extraction processor 120 can extract main landmarks using a plurality of landmark points, and calculate recognition scores of the main landmarks using the recognition scores of the plurality of landmark points (S306). For example, if any one main landmark is composed of four landmark points, the average of the recognition scores of the four landmark points can be calculated as the recognition score of the any one main landmark.

In some implementations, the face attribute extraction processor 120 can output recognition scores of main landmarks for each of the front facial area, the left facial area, and the right facial area using ae learned landmark score model. The learned landmark score model can receive a facial area as input data and output recognition scores of the main landmarks of the facial area.

The landmark points can represent main landmarks (main features) of the face, such as eyebrows, eyes, nose, mouth, and chin. That is, each main landmarks of the face can be a set of landmark points corresponding to the location of each main landmark. For example, 29 landmark points can be extracted from the face area, where landmark points 0, 2, 4, and 5 can represent the left eyebrow, landmark points 1, 3, 6, and 7 can represent the right eyebrow, landmark points 8, 10, 12, 13, and 16 can represent the left eye, landmark points 9, 11, 14, 15, and 17 can represent the right eye, landmark points 18 to 21 can represent the nose, landmark points 22 to 27 can represent the mouth, and landmark point 28 can represent the chin.

The face attribute extraction processor 120 can perform preprocessing such as face alignment so that the main landmarks are properly extracted from each of the front face area, the left face area, and the right face area.

In addition, the face attribute extraction processor 120 can determine a plurality of face attribute factors in each of the front face area, the left face area, and the right face area (S308). The plurality of face attribute factors can include gender, age, and accessories such as masks, glasses, scarves, beards, hats, bangs, etc. The plurality of face attribute factors can be classified into a constant face attribute factor that is invariant in the face area and a variable face attribute factor that is variable in the face area. For example, gender and age can be classified as the constant facial attribute factor, while accessories such as hats, bangs, glasses, sunglasses, niqabs, masks, scarves, neck gaiters, moustaches, and beards can be classified as the variable face attribute factor.

The occlusion determination processor 130 can extract attribute weights corresponding to the face attribute factors extracted from each of the front face area, the left face area, and the right face area and information on the face area to which each of the face attribute factors corresponds, by searching the face attribute lookup table 180 (S310).

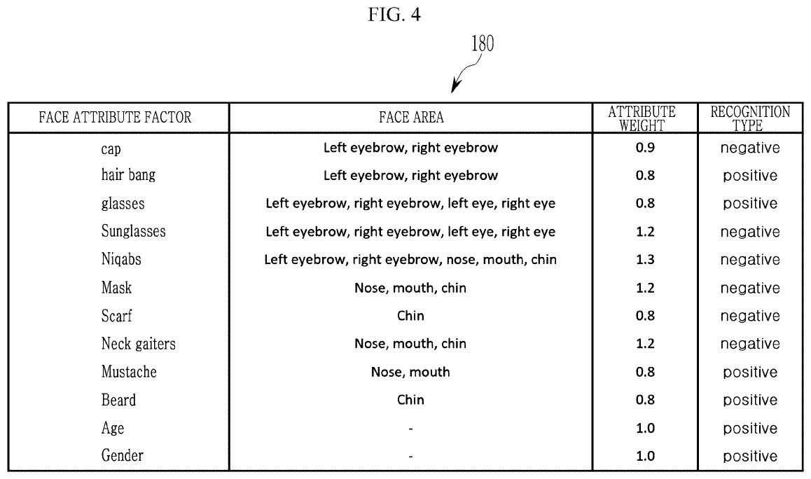

FIG. 4 is a diagram showing an example of a face attribute lookup table. Referring to FIG. 4, the face attribute lookup table 180 stores specific information about face attribute factors. The specific information about a face attribute can include a face area to which the face attribute corresponds, an occlusion weight for the face attribute factor, and a recognition type for the face attribute factor.

Types of face attribute factors include information extracted from the face area, such as hats, bangs, glasses, sunglasses, niqabs, masks, scarves, neck gaiters, mustaches, beards, age, and gender.

The face area can represent the area to which that face attribute factor applies, for example, the face area of a hat can be set to the left eyebrow and the right eyebrow, and the face area of the glasses can be set to the left eyebrow, right eyebrow, left eye, and right eye.

The recognition types can be classified into positive and negative. The positive can represent an attribute factor that should be recognized as a face attribute factor in itself. Therefore, when registering a face image of a registered user, face attribute factors corresponding to positive can be registered together. The negative can represent that the face attribute factor that interfere with face recognition. For example, since a mask is an element that interferes with face recognition, the recognition type of the mask can be set to negative. For example, since age and gender do not interfere with face recognition and are factors recognized as face attribute factors themselves, the recognition type of age and gender can be set to positive.

The occlusion weight represents the importance or influence that the corresponding face attribute factor has on face occlusion, and can be set to a value higher than 1 so that if the corresponding face attribute factor occludes the face, the corresponding face attribute factor is determined as face occlusion, and if the corresponding face attribute is not related to face occlusion, it can be set to a value lower than 1 so that the corresponding face attribute factor is not determined as face occlusion. For example, sunglasses, niqabs, and masks are face attribute factors that obscure the face and interfere with face recognition, so the occlusion weight of the sunglasses, niqabs, and masks can be set to a value greater than 1. For example, glasses or bangs are face attribute factors that obscure the face but do not significantly interfere with face recognition, so the occlusion weight of glasses or bangs can be set to a value less than 1. In this way, even if it is a face attribute factor that affects face occlusion, the occlusion weight of the face attribute factor that is sufficient for face recognition can be set to be less than 1, thereby reducing the probability of incorrectly determining that a face is occluded by the face attribute factor.

The face attribute lookup table 180 illustrated in FIG. 4 is an example, and face attribute factors and specific information about the face attribute factors can be added, changed, or deleted.

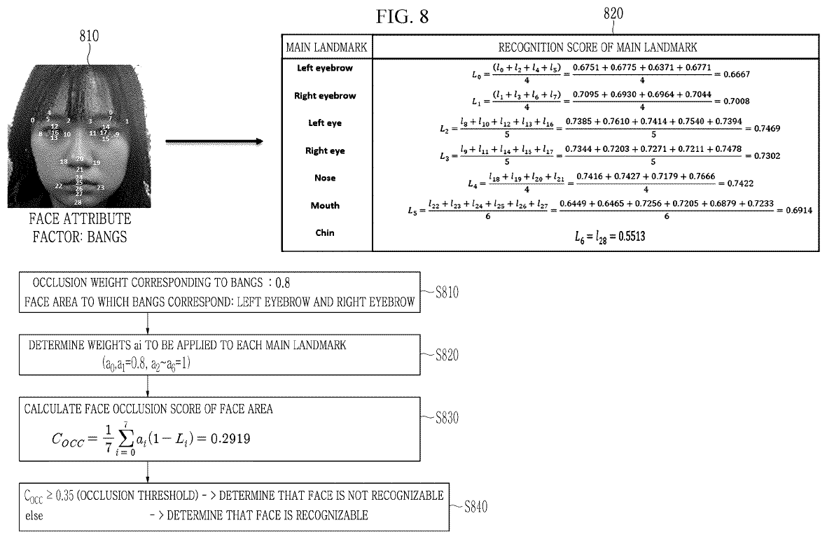

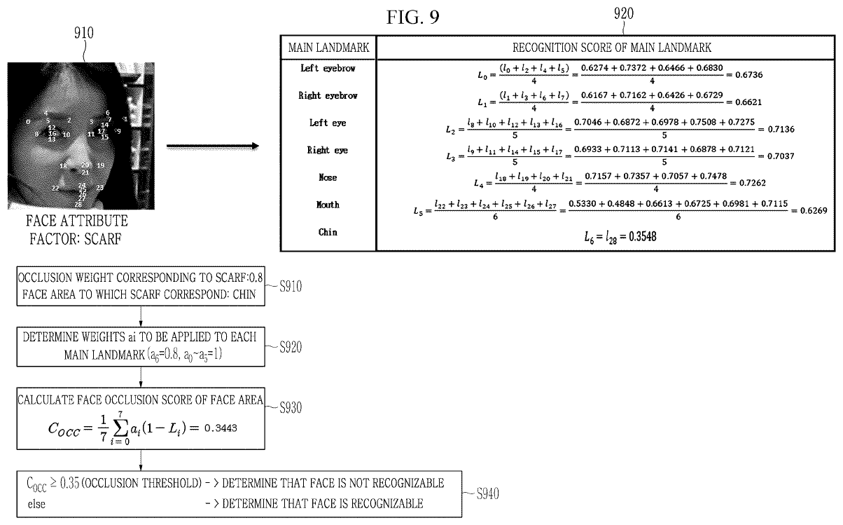

Again, referring to FIGS. 2 and 3, the occlusion determination processor 130 can calculate a face occlusion score for each of the front face area, the left face area, and the right face area (S312). The occlusion determination processor 130 can calculate an occlusion score for each of the front face area, the left face area, and the right face area by using the recognition scores of the main landmarks of the corresponding face area, the occlusion weights of the face attribute factors extracted from the corresponding face area, and the face area information of the corresponding facial attribute factors. A specific method for calculating the occlusion score of the face area is described later with reference to FIGS. 8 and 9.

The occlusion determination processor 130 compares the calculated face occlusion score for each of the front face area, left face area, and right face area with an occlusion threshold, and if the face occlusion score is greater than or equal to the occlusion threshold (S314), it determines that face recognition is impossible and outputs that user registration is impossible (S316). Then, the third camera 30 capture a face image of the user, and the access control apparatus 40 can perform the user registration process again from the step S302.

If the face occlusion score of each of the front face area, left face area, and right face area is less than the occlusion threshold (S314), the occlusion determination processor 130 determines that face recognition is possible and can proceed with user registration.

In some implementations, the occlusion determination processor 130 can use a learned occlusion determination model to calculate a face occlusion score from a face area and compare the face occlusion score with the occlusion threshold to output whether the face is recognizable. As input data for the occlusion determination model, for example, an image of a face area, recognition scores of main landmarks in the face area, occlusion weights of face attribute factors extracted from the face area, and information on the face area of the face attribute factors can be used. In contrast, an image of a face area, recognition scores of main landmarks of the face area, and face attribute factors extracted from the face area can be input as input data of the occlusion determination model, and the occlusion determination model can extract occlusion weights of face attribute factors and information of the face area of the face attribute factors from the input data, calculate a face occlusion score, compare the face occlusion score with an occlusion threshold, and output whether or not the face is recognizable.

The face feature extraction processor 140 can embed each of the front face area, the left face area, and the right face area, which are determined to be capable of face recognition, and can generate a unique feature vector for each of the front face area, the left face area, and the right face area (S318). The embedding process is to convert high-dimensional data into a low-dimensional space, that is, to map it into a vector of a certain size. The feature vector generated through the embedding process has a unique value for each user.

The registration processor 150 can store the feature vector of each of the front face area, the left face area, and the right face area, and each of the front face area, the left face area, and the right face area, in correspondence with a user key in the database 170 (S320). The user key can be any information that can identify a user. For example, employee number or resident registration number can be used as the user key. At this time, the registration processor 150 can store the positive face attribute factors extracted from the corresponding face area.

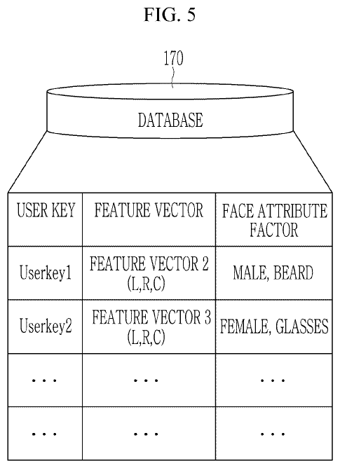

FIG. 5 is a diagram showing an example of information stored in the database illustrated in FIG. 2.

As illustrated in FIG. 5, the database 170 can store feature vectors L, R, and C of each of the left face area, the right face area, and the front face area in correspondence to the user key. In addition, the database 170 can store positive face attribute factors extracted from the corresponding face area in response to the user key.

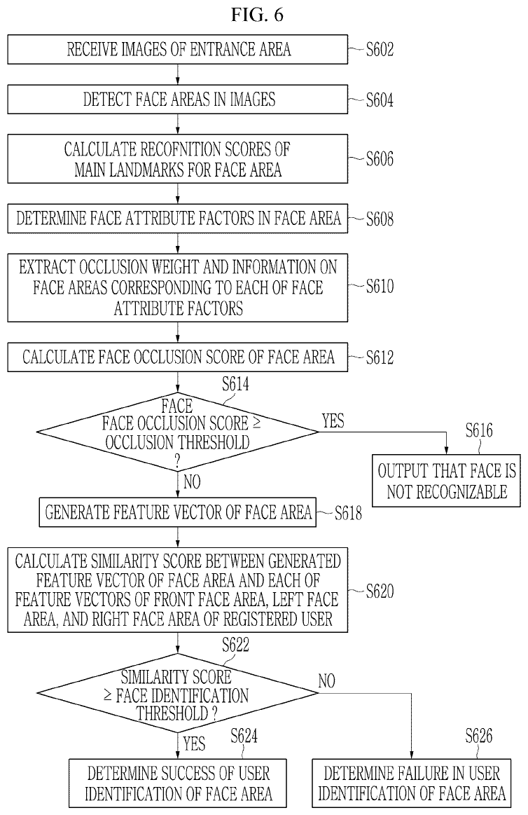

FIG. 6 is a flow chart showing an access control method of the access control apparatus illustrated in FIG. 1.

Referring to FIGS. 2 and 6 together, the face detection processor 110 receives images of the entrance area from the first and second cameras 10 and 20 (S602).

The first and second cameras 10 and 20 can capture images at the entrance locations and transmit the captured images to the face detection processor 110.

The face detection processor 110 can detect at least one face area in the image (S604).

In some implementations, the face detection processor 110 can detect a face area in each of input images using a learned face detection model.

The face attribute extraction processor 120 can extract a plurality of landmark points from the detected face area and calculate recognition scores of the plurality of landmark points.

In addition, the face attribute extraction processor 120 can extract main landmarks from a detected face area using the plurality of landmark points, and calculate recognition scores of main landmarks for the face area using the recognition scores of the plurality of landmark points (S606).

In some implementations, the face attribute extraction processor 120 can output recognition scores of main landmarks for the face region using a learned landmark score model.

The face attribute extraction processor 120 can perform preprocessing such as face alignment so that main landmarks are well extracted from the face area.

Furthermore, the face attribute extraction processor 120 can determine face attribute factors in the face area (S608).

The face attribute extraction processor 120 can search a face attribute lookup table, and extract an occlusion weight corresponding to each of face attribute factors and information on face areas to which each of the face attribute factors corresponds (S610).

The occlusion determination processor 130 can calculate a face occlusion score of the face area (S612). The occlusion determination processor 130 can calculate a face occlusion score of the face area by using the recognition scores of main landmarks of the face area, the occlusion weights of face attribute factors extracted from the corresponding face area, and the face area information of the corresponding face attribute factor.

The occlusion determination processor 130 compares the face occlusion score of the face area with the occlusion threshold, and if the face occlusion score is greater than or equal to the occlusion threshold (S614), it determines that the face is not recognizable and outputs that the face is not recognizable (S616).

Meanwhile, if the face occlusion score of the face area is less than the occlusion threshold (S614), the occlusion determination processor 130 can determine whether the face is recognizable and perform a user identification process.

The face feature extraction processor 140 can generate a feature vector by embedding the face area determined to be recognizable (S618).

The identification processor 160 calculates a similarity score between the generated feature vector of the face area and each of the feature vectors of the front face area, left face area, and right face area of registered user stored in the database 170 (S620), and can identify the user of the corresponding face area based on the calculated similarity scores. The similarity score SC can be calculated as shown in Equation 11.

$$SC = {S}_{A 1 , L} + {S}_{A 1 , C} + {S}_{A 1 , R} \qquad ( Equation 1 )$$

In Equation 1, A1 represents the generated feature vector of the face area, and L, C, and R represent a feature vector of the left face area of the registered user, a feature vector of the front face area of the registered user, and a feature vector of the right face area of the registered user. S_{A1,L} can represent a left similarity score indicating the similarity between the generated feature vector of the face area and the feature vector of the left face area of the registered user, S_{A1,C} can represent a front similarity score indicating the similarity between the generated feature vector of the face area and the feature vector of the front face area of the registered user, and S_{A1,R} can represent a right similarity score indicating the similarity between the generated feature vector of the face area and the feature vector of the right face area of the registered user.

In this way, the similarity score can be calculated by adding the left similarity score, the right similarity score, and the front similarity score. Alternatively, the similarity score can be calculated by averaging the sum of the left similarity score, the right similarity score, and the front similarity score.

In some implementations, the similarity score SC can be calculated by applying different weights to the left similarity score, the right similarity score, and the front similarity score according to the face angle of the detected face area, as in Equation 2.

$$SC = {w}_{L} \times {S}_{A 1 , L} + {w}_{C} \times {S}_{A 1 , C} + {w}_{R} \times {S}_{A 1 , R} \qquad ( Equation 2 )$$

In Equation 2, w_{L} can represent a left weight applied to the left similarity score, w_{C} can represent a front weight applied to the front similarity score, and w_{R} can represent a right weight applied to the right similarity score.

The left weight, front weight, and right weight can be determined by referring to the angle weight lookup table 190 according to the face angle of the face area.

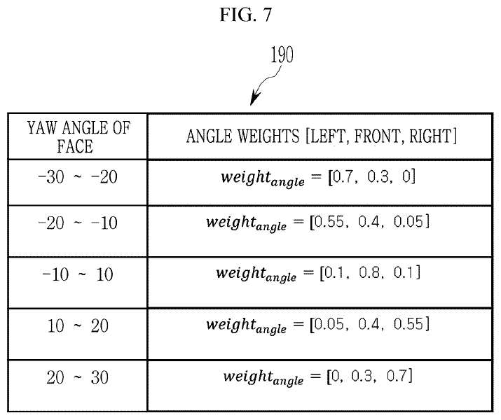

FIG. 7 is a diagram illustrating an example of an angular weight lookup table.

Referring to FIG. 7, the angle weight lookup table 190 has a left weight, a front weight, and a right weight set according to a yaw angle of the face area.

The identification processor 160 can extract angle weights corresponding to the yaw angle of the detected face area by searching the angle weight lookup table 190, and calculate the similarity score between the feature vector of the detected face area and each of the feature vectors of each registered user according to Equation 2.

The yaw angle of the face area can be extracted by the face attribute extraction processor 120.

In general, face recognition performance tends to deteriorate when detecting a side face. However, in some implementations, the identification processor 160 can improve the face recognition rate even when a side face area is detected by applying different weights to the left similarity score, the front similarity score, and the right similarity score according to the yaw angle of the detected face area.

Again, referring to FIG. 6, if the calculated similarity score is greater than or equal to the face identification threshold, the identification processor 160 determines a success in user identification of the corresponding face area and allows entry of the corresponding user.

Meanwhile, if the calculated similarity score is less than the face identification threshold, the identification processor 160 can determine a failure in user identification of the corresponding face area and output an image of the corresponding face area and the identification failure. At this time, the identification processor 160 can output an alarm notifying the occurrence of an unidentified entrant.

In some implementations, the identification processor 160 can identify a user in the face area using a learned user identification model. The identification processor 160 can input the generated feature vector of the face area into the user identification model, and the user identification model can identify the user of the face area through the similarity measurement described above and output the identification results.

In addition, in some implementations, when user identification of the face area fails, the identification processor 160 can search a database 170 based on the face attribute factors of the face area to search for a user candidate group with the same face attribute factor, and output the searched user candidate group.

FIG. 8 is a diagram illustrating a method for calculating a face occlusion score for a single face area.

Referring to FIG. 8, it is assumed that the bangs is extracted as a face attribute factor of the face area 810 by the face attribute extraction processor 120, and the recognition scores 820 of the main landmarks of the face area 810 are calculated.

The occlusion determination processor 130 can detect for the occlusion weight and face area corresponding to the bangs by querying the face attribute lookup table 180 (S810). Referring to the face attribute lookup table 180 illustrated in FIG. 4, the occlusion weight corresponding to the bangs is 0.8, and the face area of the bangs is the left eyebrow and right eyebrow areas. At this time, the recognition type of the bangs is positive, which is an attribute that does not interfere with face recognition.

The occlusion determination processor 130 can determine weights aᵢ to be applied to each main landmark based on the recognition scores 820 of the main landmarks of the face area 810 and the occlusion weight corresponding to the bangs, which is a face attribute factor, and the face area of the bangs (S820). The occlusion weight corresponding to the bangs is 0.8, and since the face area to which the bangs corresponds is the left eyebrow area and the right eyebrow area, the occlusion determination processor 130 can determine the attribute weights a₀ and a₁ of the main landmarks i (i=0, 1) corresponding to the left eyebrow area and the right eyebrow area as 0.8, respectively, and determine the attribute weights a₂ to a₆ of the remaining main landmarks i (i=2 to 6) as 1, respectively.

The occlusion determination processor 130 can calculate the face occlusion score of the face area 810 by using the weight aᵢ to be applied to each main landmark and the recognition scores 820 of the main landmarks (S830). The face occlusion score can be calculated as shown in Equation 3.

$${C}_{OCC} = \frac{1}{N} {\sum }_{i = 0}^{N} {a}_{i} ( 1 - {L}_{i} ) \qquad ( Equation 3 )$$

Here, i can represent an index of a main landmark. Li represents the recognition score of the main landmark i, and aᵢ can represent the weight applied to the main landmark i.

In the case of the face area 810 illustrated in FIG. 8, the number of main landmarks, N, is 7, and when the face occlusion score is calculated using the weight aᵢ to be applied to each main landmark and the recognition scores 820 of the main landmarks, it can be expressed as in Equation 4.

$${C}_{OCC} = \frac{1}{7} {\sum }_{i = 0}^{7} {a}_{i} ( 1 - {L}_{i} ) = 0.2919 \qquad ( Equation 4 )$$

The occlusion determination processor 130 compares the face occlusion score of the face area 810 with the occlusion threshold, and if the face occlusion score of the face area 810 is equal to or greater than the occlusion threshold, it can determine that the face is not recognizable (S840).

Meanwhile, the occlusion determination processor 130 can determine that the face is recognizable if the face occlusion score of the face area 810 is less than the occlusion threshold.

For example, the occlusion threshold can be set to 0.35, and since the face occlusion score of the face region 810 calculated according to Equation 4 is less than the occlusion threshold of 0.35, the occlusion determination processor 130 can determine that a face is recognizable from the face area 810.

FIG. 9 is a diagram illustrating a method for calculating a face occlusion score for another face area.

Referring to FIG. 9, it is assumed that a scarf is extracted as a face attribute factor of a face area 910 by the face attribute extraction processor 120, and recognition scores 920 of main landmarks of the face area 910 are calculated.

The occlusion determination processor 130 can detect the occlusion weight and face area corresponding the scarf by searching the face attribute lookup table 180 (S910). Referring to the face attribute lookup table 180 illustrated in FIG. 4, the occlusion weight corresponding to the scarf is 0.8, and the face area of the scarf is the chin area.

The occlusion determination processor 130 can determine the weights aᵢ to be applied to each main landmark based on the recognition scores 920 of the main landmarks of the face area 910 and the occlusion weight corresponding to the scarf, which is a face attribute factor, and the face area of the scarf (S920). The occlusion weight corresponding to the scarf is 0.8, and since the face area to which the scarf corresponds is the chin area, the occlusion determination processor 130 can determine the weight a₆ of the main landmark i (i=6) corresponding to the chin area as 0.8, and determine the weights a₀ to a₆ of the remaining main landmarks i (i=0 to 5) as 1, respectively.

The occlusion determination processor 130 can calculate the face occlusion score of the face area 910 as in Equation 5 by using the weight aᵢ to be applied to each main landmark and the recognition scores 920 of the main landmarks (S930).

$${C}_{OCC} = \frac{1}{7} {\sum }_{i = 0}^{7} {a}_{i} ( 1 - {L}_{i} ) = 0.443 \qquad ( Equation 5 )$$

The occlusion determination processor 130 can compare the face occlusion score of 0.443 of the face area 910 with the occlusion threshold of 0.35, and determine whether the face is not recognizable or recognizable from the face area 910.

The occlusion determination processor 130 can determine that the face is recognizable if the face occlusion score of 0.443 of the face area 910 calculated by Equation 5 is less than the occlusion threshold of 0.35 (S940).

Meanwhile, when the face occlusion score of the face area 910 is calculated based on Equation 6 without applying weights to each main landmark according to the face attribute factors, the face occlusion score of the face area 910 is greater than the occlusion threshold value of 0.35, unlike Equation 5.

$${C}_{OCC} = \frac{1}{N} {\sum }_{i = 0}^{N} ( 1 - {L}_{i} ) = 0.3627 , ( N = 7 ) \qquad ( Equation 6 )$$

That is, if weights are not applied to each main landmark according to face attribute factors, the face area 910 can be determined that the face is not recognizable even though it is an image in which a face can be recognized.

In this way, the occlusion determination processor 130 can improve the face recognition performance by filtering the occluded face area by using the recognition scores of the main landmarks, the occlusion weights of the face attribute factors extracted from the corresponding face area, and the information of the face area of the corresponding face attribute factors.

In addition, the occlusion determination processor 130 calculates a face occlusion score for the face area 910 by applying weights to each main landmark according to face attribute factors, thereby more accurately determining whether a face can be recognized.

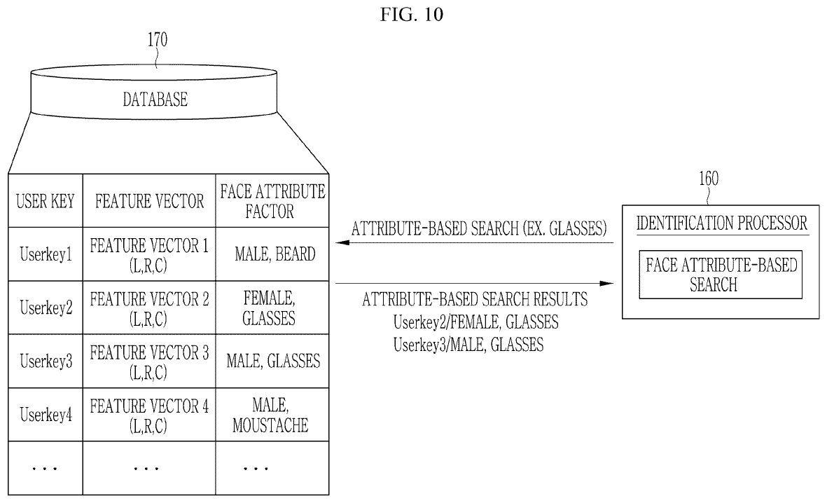

FIG. 10 is a diagram illustrating a facial attribute-based search method when user identification of the face area illustrated in FIG. 6 fails.

Referring to FIG. 10, when identification of a face area in an image fails, the identification processor 160 can search the database 170 based on face attribute factors extracted from the face area and output face attribute-based search results.

For example, if a face attribute factor called glasses is extracted from a face area, the identification processor 160 can search a user key registered as the face attribute factor called glasses in a database 170 and provide the user key and face attribute information having glasses as a face attribute factor as search results.

In addition, the identification processor 160 can search the database 170 using the user key and delete information of a registered user stored in response to the user key from the database 170 using the user key.

In some implementations, the access control method of the access control apparatus 40 can be implemented as a computer program on a computer-readable storage medium.

In some implementations, the computer-readable recording medium can be a removable recording medium or a fixed recording medium. In some implementations, a computer program recorded on a computer-readable recording medium can be transmitted to another computing device through a network such as the Internet and installed and executed on the other computing device.

In some implementations, by detecting a plurality of face areas from images captured by a plurality of cameras capturing an entry area, identifying users of the plurality of face areas, and detecting unidentified users, delay in entrance when a plurality of entrants occur can be eliminated.

In addition, in some implementations, when identifying a user in a face area, it is possible to accurately detect whether a face is recognized due to face occlusion by applying face attribute weights, and when calculating the similarities between feature vectors, it is possible to improve face identification performance by applying weights according to a face angle.

What is claimed is:

1. An access control method performed by executing one or more instructions stored in memory by a processor, the access control method comprising:
receiving an image of an entrance area;
detecting at least one face area in the image;
calculating a plurality of recognition scores, each indicating a recognition degree for a corresponding one of a plurality of main landmarks within the at least one face area;
determining a plurality of face attribute factors in the at least one face area;
extracting, by searching a face attribute lookup table, (i) a plurality of occlusion weights of the plurality of face attribute factors, each occlusion weight indicating a degree to which a corresponding face attribute factor contributes to face occlusion and (ii) face area information corresponding to each face attribute factor;
calculating a face occlusion score of the at least one face area based on the plurality of recognition scores of the plurality of main landmarks, the plurality of occlusion weights of the plurality of face attribute factors, and the face area information;
determining, based on the face occlusion score of the at least one face area, whether face recognition can be performed for the at least one face area;
identifying, from among the at least one face area deemed suitable for the face recognition, a user corresponding to a first face area; and
notifying, based on the identification of the user being failed, an image of the first face area and a user identification failure.

2. The access control method of claim 1, wherein calculating the face occlusion score includes:
setting, for each of the plurality of main landmarks, a weight based on the face area information, such that main landmarks corresponding to the face area information are assigned occlusion weights associated with the face attribute factors, and remaining main landmarks are assigned a default weight of 1; and
calculating a face occlusion score by (i) multiplying a first value of each of the plurality of main landmarks, which is derived from the recognition score of each of the plurality of main landmarks, by the assigned weight of the main landmark and (ii) averaging a sum of the resulting weighted values.

3. The access control method of claim 2, wherein:
the face attribute lookup table includes the plurality of occlusion weights of the plurality of face attribute factors based on a type of each of the plurality of face attribute factors, and the face area information to which a corresponding face attribute factor belongs, and
occlusion weights associated with face attribute factors that contribute to face occlusion are set to values greater than 1, and occlusion weights associated with face attribute factors unrelated to face occlusion are set to values less than 1.

4. The access control method of claim 2, wherein the first value is a value obtained by subtracting the recognition score of the corresponding main landmark from 1.

5. The access control method of claim 2, wherein determining whether face recognition can be performed includes:
determining, based on the face occlusion score of any one face being greater than or equal to a set first threshold, that a face recognition of the any one face area cannot be performed; and
determining, based on face occlusion score of the any one face being less than the first threshold, that a face recognition of the any one face area can be performed.

6. The access control method of claim 1, wherein identifying a user includes:
generating a first feature vector of the first face area; and
verifying the user of the first face area by using a similarity measurement between the first feature vector and each of feature vectors of a plurality of face images of each of registered users with access authentication stored in a database.

7. The access control method of claim 6, wherein:
the database includes a second feature vector of a front face image, a third feature vector of a left face image, and a fourth feature vector of a right face image, stored in correspondence with a user key of each of the registered users, and
verifying the user includes:
calculating a first similarity between the first feature vector and the second feature vector of each registered user, a second similarity between the first feature vector and the third feature vector of each registered user, and a third similarity between the first feature vector and the fourth feature vector of each registered user;
calculating a sum of the first similarity, the second similarity, and the third similarity calculated with each registered user; and
determining, based on the calculated sum being less than a face identification threshold, that an identification of the user of the first face area has failed.

8. The access control method of claim 7, further comprising:
extracting a yaw angle of the first face area,
wherein verifying the user further includes:
extracting a front weight, a left weight, and a right weight corresponding to the yaw angle of the first face area by referring to an angle weight lookup table in which front weights, left weights, and right weights are set for a plurality of face yaw angles, and
wherein calculating the sum includes multiplying the first similarity by the front weight, multiplying the second similarity by the left weight, and multiplying the third similarity by the right weight, and then summing them.

9. The access control method of claim 6, further comprising:
extracting a feature vector of a front face image of each registered user, a feature vector of a left face image of each registered user, and a feature vector of a right face image of each registered user; and
registering, in the database, the feature vector of a front face image of each registered user, the feature vector of a left face image of each registered user, and the feature vector of a right face image of each registered user in correspondence with a user key of each registered user.

10. The access control method of claim 9, wherein extracting a feature vector includes:
detecting a second face area from each of the front face image, the left face image, and the right face image;
calculating a plurality of recognition scores of a plurality of main landmarks in the second face area of each of the front face image, the left face image, and the right face image;
determining a plurality of face attribute factors in the second face area;
extracting, by searching the face attribute lookup table, a plurality of attribute weights of the plurality of face attribute factors and face area information to which the plurality of face attribute factors correspond;
calculating a face occlusion score of the second face area based on the plurality of recognition scores of the plurality of main landmarks, occlusion weights of the extracted plurality of face attribute factors, and the face area information;
determining, based on the face occlusion score of the second face area, whether face recognition can be performed for the second face area; and
generating, based on a determination that the face recognition can be performed, the feature vector of each of the front face image, the left face image, and the right face image.

11. The access control method of claim 10, wherein registering the feature vectors includes registering the face attribute factors corresponding to the user key, based on the face attribute factors determined in the second face area of each of the front face image, the left face image, and the right face image are a positive attribute factor that does not interfere with face recognition.

12. An access control apparatus comprising:
a memory storing one or more instructions; and
a processor configured to execute one or more instructions to perform operations comprising:
detecting at least one face area in an image of an entrance area,
calculating a plurality of recognition scores, each indicating a recognition degree for a corresponding one of a plurality of main landmarks within the at least one face area,
determining a plurality of face attribute factors in the at least one face area,
extracting, by searching a face attribute lookup table, (i) a plurality of occlusion weights of the plurality of face attribute factors, each occlusion weight indicating a degree to which a corresponding face attribute factor contributes to face occlusion and (ii) face area information corresponding to each face attribute factor,
calculating a face occlusion score of the at least one face area based on the plurality of recognition scores of the plurality of main landmarks, the plurality of occlusion weights of the plurality of face attribute factors, and the face area information,
determining, based on the face occlusion score of the at least one face area, whether face recognition can be performed for the at least one face area,
identifying, from among the at least one face area deemed suitable for the face recognition, a user corresponding to a first face area, and
notifying, based on the identification of the user being failed, an image of the first face area and a user identification failure.

13. The access control apparatus of claim 12, wherein calculating the face occlusion score includes:
setting, for each of the plurality of main landmarks, a weight based on the face area information, such that main landmarks corresponding to the face area information are assigned occlusion weights associated with the face attribute factors, and remaining main landmarks are assigned a default weight of 1, and
calculating a face occlusion score by (i) multiplying a first value of each of the plurality of main landmarks, which is derived from the recognition score of each of the plurality of main landmarks, by the assigned weight of the main landmark and (ii) averaging a sum of the resulting weighted values.

14. The access control apparatus of claim 13, wherein:
the face attribute lookup table includes the plurality of occlusion weights of the plurality of face attribute factors based on a type of each of the plurality of face attribute factors, and the face area information to which a corresponding face attribute factor belongs,
occlusion weights associated with face attribute factors that contribute to face occlusion are set to values greater than 1, and occlusion weights associated with face attribute factors unrelated to face occlusion are set to values less than 1, and
the operations comprise searching the face attribute lookup table, and extracting attribute weights of the plurality of face attribute factors and the face area information.

15. The access control apparatus of claim 13, wherein the first value is a value obtained by subtracting the recognition score of the corresponding main landmark from 1.

16. The access control apparatus of claim 13, wherein determining whether face recognition can be performed includes:
determining, based on the face occlusion score of any one face being greater than or equal to a set first threshold, that a face recognition of the any one face area cannot be performed, and
determining, based on face occlusion score of the any one face being less than the first threshold, that a face recognition of the any one face area can be performed.

17. The access control apparatus of claim 12, further comprising
a database configured to store a plurality of feature vectors of a plurality of face images of each registered user,
wherein identifying a user includes
generating a first feature vector of the first face area, and
verifying the user of the first face area by using a similarity measurement between the first feature vector and each of feature vectors of the plurality of face images of each registered user stored in the database.

18. The access control apparatus of claim 17, wherein:
the feature vectors of a plurality of face images include a second feature vector of a front face image, a third feature vector of a left face image, and a fourth feature vector of a right face image, stored in correspondence with a user key of each of the registered users, and
verifying the user includes:
calculating a first similarity between the first feature vector and the second feature vector of each registered user, a second similarity between the first feature vector and the third feature vector of each registered user, and a third similarity between the first feature vector and the fourth feature vector of each registered user,
calculating a sum of the first similarity, the second similarity, and the third similarity calculated with each registered user, and
determining, based on the calculated sum being less than a face identification threshold, that an identification of the user of the first face area has failed.

19. The access control apparatus of claim 18,
wherein the operations further comprise extracting a yaw angle of the first face area,
wherein verifying the user further includes:
extracting a front weight, a left weight, and a right weight corresponding to the yaw angle of the first face area by referring to an angle weight lookup table in which front weights, left weights, and right weights are set for a plurality of face yaw angles,
wherein calculating the sum includes multiplying the first similarity by the front weight, multiplying the second similarity by the left weight, and multiplying the third similarity by the right weight, and then summing them.

20. The access control apparatus of claim 17, wherein extracting a feature vector includes:
detecting a second face area from each of a front face image, a left face image, and a right face image of each registered user,
calculating a plurality of recognition scores of a plurality of main landmarks in the second face area of each of the front face image, the left face image, and the right face image,
determining a plurality of face attribute factors in the second face area,
extracting, by searching the face attribute lookup table, a plurality of attribute weights of the plurality of face attribute factors and face area information to which the plurality of face attribute factors correspond,
calculating a face occlusion score of the second face area based on the plurality of recognition scores of the plurality of main landmarks, occlusion weights of the extracted face attribute factors, and the face area information,
determining, based on the face occlusion score of the second face area, whether face recognition can be performed for the second face area, and
generating, based on a determination that the face recognition can be performed, the feature vector of each of the front face image, the left face image, and the right face image.
